(19) United States
(12) Patent Application Publication
(10) Pub. No.: US 2024/0046146 A1
(43) Pub. Date: Feb. 8, 2024

(54) METHOD FOR TEACHING AN ELECTRONIC COMPUTING DEVICE, A COMPUTER PROGRAM PRODUCT, A COMPUTER-READABLE STORAGE MEDIUM AS WELL AS AN ELECTRONIC COMPUTING DEVICE

(71) Applicant: Siemens Aktiengesellschaft, München (DE)

(72) Inventors: Steffen Limmer, München (DE); Nicola Michailow, München (DE); Marc Christian Weber, München (DE); Daniel Hein, München (DE); Volkmar Sterzing, Neubiberg (DE); Alberto Martinez Alba, München (DE)

(21) Appl. No.: 18/229,886

(22) Filed: Aug. 3, 2023

(30) Foreign Application Priority Data
Aug. 5, 2022 (EP) 22189108.8

(51) Int. Cl. G06N 20/00

(52) U.S. Cl. CPC G06N 20/00

(57) ABSTRACT

A method for teaching an electronic computing device includes at least a machine learning algorithm for predicting a position-based propagation of radio waves in an environment, including the steps of: providing a mathematical model for the position-based propagation, wherein the mathematical model includes at least a physical model for the position-based propagation in the environment generating training data for the machine learning algorithm including a propagation field and/or a propagation domain; training the machine learning algorithm by fitting the training data to a partial derivative of the machine learning algorithm; and obtaining a prediction of a propagation loss by a weighted sum of multiple evaluations of the trained machine learning algorithm. Furthermore, provided is a computer program product, a computer-readable storage medium as well as an electronic computing device.

### CROSS-REFERENCE TO RELATED APPLICATIONS

This application claims priority to EP Application No.22189108.8, having a filing date of Aug. 5, 2022, the entire contents of which are hereby incorporated by reference.

### FIELD OF TECHNOLOGY

The following relates to a method for teaching an electronic computing device comprising at least a machine learning algorithm for predicting a position-based propagation in an environment. Furthermore, the following relates to a method for using the trained electronic computing device, to a computer program product, to a computer-readable storage medium as well as to an electronic computing device for predicting a propagation in an environment.

### BACKGROUND

Learning a prediction of path loss maps and spatial-loss fields in wireless cellular networks is an important problem used for main downstream tasks such as localization and quality of service prediction, for example, data rate, latency, upcoming connection loss or furthermore. Such path loss maps and spatial-loss fields are referred to by the general term ‘propagation loss’ in the following. These tasks are often based on received signal strength indicators (RSSI) of the signal. RSS-information is a standard feature in most current wireless protocols. For example, RSSI is used to trigger handovers and to enable UE-BS-association for load balancing purposes. Therefore, exploiting signal strength information for learning a prediction of path loss maps, spatial-loss fields and solving downstream tasks such as localization is attractive since RSSI is a feature already built-in the wireless protocols and does not require any further specific signal processing at the UE. On the other hand, the time-based and angle-based methods require high-precision clocks and antenna arrays, which make them unfavorable for implementation, respectively. One draw-back of the usage of RSSI is a high calibration effort, which is necessary in order to achieve a satisfactory accuracy in structured environments. Calibration is typically necessary to account for a complex propagation behavior in structured environments as typically found inside buildings and dense building areas. Propagation environments are typically influenced also by individual objects such as walls, furniture and machinery or buildings which can only be modelled to a certain granularity and therefore often have to be regarded as uncertain.

U.S. Pat. No. 8,102,314 B2 relates to a position-finding method for determining the location of a mobile object. The features, for example received field strengths, of a plurality of base stations are measured, and the object position is located from these features, using a reference map. During an initialization process, a reference map is created which comprises a multiplicity of positions and the associated feature-dependent values. During use of the method, a plurality of position-finding processes are carried out, by means of each of which a measured feature-dependent value and from this, a located position of the object, are determined using the predetermined reference map. The predetermined reference map is in each case updated for at least some of the positions found, during which updates, the feature-dependent values are each corrected by a correction term at the support points of the reference map in a predetermined area surrounding an object position.

### SUMMARY

An aspect relates to provide a method, a computer program product (non-transitory computer readable storage medium having instructions, which when executed by a processor, perform actions), a computer-readable storage medium as well as an electronic computing device by which a more efficient predicting of a position-based propagation of radio waves in an environment is performed.

One aspect of embodiments of the invention relate to a method for teaching an electronic computing device comprising at least a machine learning algorithm for predicting a position-based propagation of radio waves in an environment. A mathematical model for the position-based propagation is provided, wherein the mathematical model comprises at least a physical model for the propagation in the environment. Training data is generated for the machine learning algorithm comprising a propagation field and/or a propagation domain. The machine learning algorithm is trained by fitting the training data to a partial derivative of the machine learning algorithm and a prediction of a propagation loss is obtained by a weighted sum of multiple evaluations of the trained machine learning algorithm.

Therefore, a method may be provided to perform physics-aware prediction and learning based on path loss measurements and an approximate modelling of side-information via a spatial-loss field. The proposed method may use a physics-based problem formulation to achieve higher prediction accuracy which would enable higher accuracy of downstream tasks such as localization and mapping. In addition, the approach can be used to obtain structural information about the environment in uncertain or unknown areas via completion of the spatial-loss field, e.g., based on RSSI measurements.

Therefore, compared to previously known machine learning approaches, such a physics-aware network may include physical dependencies between spatial-loss fields and a measured path loss in the training phase of the neural network. This may improve generalization and prediction quality and may reduce training time, amount of required training data, and number of neural network parameters which results in faster interference time. Furthermore, compared to previously known machine learning approaches, for example, convolutional networks, or simulation methods, for example raytracing, based on finite difference time domain, a learned physics-aware network may account for uncertainty and partial information of the environment geometry by using partial training data of the spatial-loss field and path loss data only for coordinates where it is known.

Compared to simulation methods, it may be possible to calculate derivatives of a learned spatial-loss field and a learned path loss map which may allow for faster solution of downstream tasks such as localization. Compared to simulation methods, for example, raytracing or based on finite difference time domain, a physics-aware network may easily include real-world path loss measurements and thereby provide easier calibration and better simulation to real transfer in a form of more accurate predictions of path loss and spatial-loss field in the real environment. Furthermore, compared to simulation methods, a learned network can use path loss data to reconstruct a spatial-loss field which can be used to determine significant changes in the propagation environment, for example, the presence or absence of large obstacles.

Furthermore, compared to simulation methods, a physics-aware network may be realized as a bayesian neural network or an ensemble of neural networks to model uncertainties of the spatial-loss fields or path loss maps, for example, due to the presence or absence of large obstacles or variations in the propagation due to humidity.

In particular, one step is to use the new machine learning method that is based on the known laws of physics in particular represented by a spatial-loss field (SLF) and/or path loss measurements of a radio propagation problem. Such a spatial loss field may be based on a floor plan and on obstacle material properties. One or more spatial loss fields and/or RSSI path loss measurements may be used as training data.

According to an embodiment, training data additionally comprises second training data of propagation measurements and training the machine learning algorithm additionally comprises fitting the second training data to weighted sums of evaluations of the machine learning algorithm. Therefore, the mathematical model is provided in an efficient way, wherein with the second training data an improved simulation of the environment may be realized.

According to another embodiment, the mathematical model comprises at least additionally a transmission power parameter and a free-space parameter of the propagation loss. The transmission power parameter may particularly quantify a transmission power. The free-space parameter may quantify a free-space path loss, a free-space attenuation factor or a power attenuation in free-space. Therefore, the mathematical model can simulate the transmission power and the free-space in order to provide a complete model to simulate the position-based propagation.

According to another embodiment, the propagation loss prediction comprises a calculation of integrals over the propagation domain as line integrals over a propagation field. This reduces the dimensionality of the integration and training effort of the mathematical model.

In another embodiment, a dimensionality of the propagation loss simulation is reduced by using a Radon transformation. Therefore, x/y are transformed to the Radon coordinates in order to reduce the dimensionality of the integration and the training effort.

In another embodiment, the propagation loss prediction comprises a calculation of a two- or three-dimensional integral over a propagation field. Therefore, the mathematical model is provided in an easy way in order to predict a position-based propagation of radio waves with little effort.

According to another embodiment, for the propagation field at least one physical parameter of the environment is predefined. As an example, the physical parameter may specify a material of an obstacle of the environment. Therefore, an efficient predicting of a position-based propagation of radio waves may be realized.

In another embodiment, the at least one physical parameter defines environment geometry information via transmission coefficients, in particular by means of spatially-resolved transmission coefficients. In particular, with the physical parameter in the form of transmission coefficients, the radio waves travelling between a different transmission receiver path through a common building material such as a drywall, Plexiglas, blinds, glass, plywood or furthermore can be simulated in an efficient way.

According to another embodiment, the machine learning algorithm is provided as a neural network. Therefore, an efficient machine learning algorithm is provided, wherein the neural network may be, for example, a supervised neural network or an unsupervised neural network.

A second aspect of embodiments of the invention relate to a method for using the trained electronic computing device, wherein the position-based propagation in the environment is predicted by optimizing parameters of the neural network based on a loss descent direction, in particular by minimizing a deviation between a predicted position-based propagation of radio waves and a measured position-based propagation of radio waves.

According to an embodiment, a propagation field simulation is evaluated by the derivative of the machine learning algorithm and/or the propagation loss is evaluated by weighted sum of multiple evaluations of the machine learning algorithm.

In particular, the present methods are computer implemented methods. Therefore, a further aspect of embodiments of the invention relates to a computer program product comprising program code means for performing the method according to the first aspect of embodiments of the invention or the second aspect of embodiments of the invention.

A still further aspect of embodiments of the invention relates to a computer-readable storage medium comprising at least the computer program product according to the preceding aspect.

Another aspect of embodiments of the invention relates to an electronic computing device for predicting a propagation in an environment, comprising at least one machine learning algorithm, wherein the machine learning algorithm is trained by a method according to the first aspect of embodiments of the invention.

A still further aspect of embodiments of the invention relates to an electronic computing device for predicting a propagation in an environment, comprising at least one trained machine learning algorithm, wherein the electronic computing device is configured for performing a method according to the second aspect of embodiments of the invention.

The electronic computing device may comprise processors, electrical circuits, for example, integrated circuits, or further electronic means for performing the method. In particular, the methods are performed by the electronic computing device.

For use cases or use situations, which may arise in the method and which are not explicitly described here, it may be provided that, in accordance with the method, an error message and/or a prompt for user feedback is output and/or a default setting and/or a predetermined initial state is set.

### BRIEF DESCRIPTION

Some of the embodiments will be described in detail, with reference to the following figures, wherein like designations denote like members, wherein:

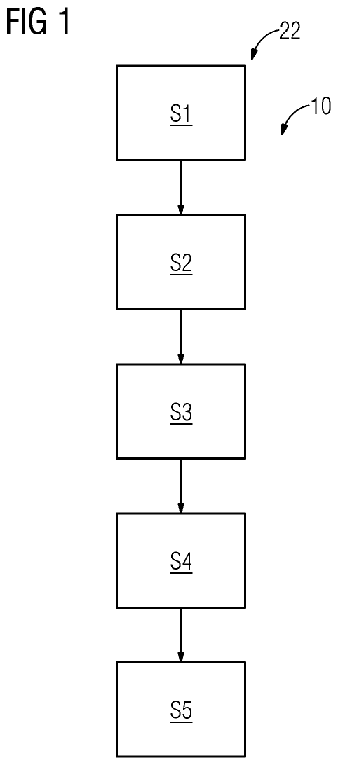

FIG. 1 shows a schematic flow chart according to an embodiment of the invention; and

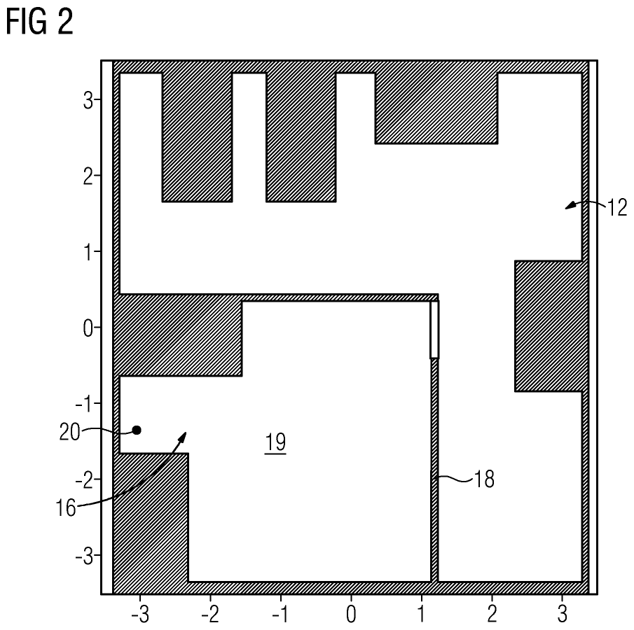

FIG. 2 shows a top view of an environment.

### DETAILED DESCRIPTION

In the figures the same elements are indicated by the same reference signs.

FIG. 1 shows a schematic flow chart according to an embodiment of the invention. In particular, the method which is shown in FIG. 1 is performed by an electronic computing device 10, which is just schematically shown.

The embodiment may particularly refer to predicting a position-based propagation of radio waves in an environment 14 (FIG. 2), e.g., a room in a building or an area within a city, of a wireless cellular network. In such a wireless cellular network the prediction may comprise a prediction of path loss maps and spatial-loss fields. In the present application such path loss maps and spatial-loss fields are referred to by the general term ‘propagation loss’.

The general term ‘field’ may refer to a spatially-resolved scalar field or a spatially resolved vector or tensor field.

From that a location of a cellular phone, a quality of service, a data rate, a latency, and/or an upcoming connection loss may be predicted or determined. This information may in turn be used to control a connection of a cellular phone proactively.

FIG. 1 shows that in a first step S1 a physics-aware loss function Loss comprising mixed partial derivatives of a machine learning algorithm implemented as neural network is defined. The neural network may be given as a function NN(θ,x,y) returning a spatial field value, where θ denotes the vector trainable parameters of the neural network, e.g. the weights of the neural connections and/or the biases of its neurons, x and y denote spatial 2d-coordinates of the propagation domain of the radio waves. The partial derivatives

$$\frac{d}{dx} \frac{d}{dy} NN ( θ , x , y )$$

of the neural network NN are calculated with respect to the spatial coordinates x and y and are preferably evaluated at several predefined positions (xᵢ, yᵢ) as

$$\frac{d}{dx} \frac{d}{dy} NN ( θ , {x}_{i} , {y}_{i} )$$

Here, i donates an index of predetermined positions within the propagation domain.
The terms

$$\frac{d}{dx} \frac{d}{dy} NN ( θ , {x}_{i} , {y}_{i} )$$

may be calculated at training time for the predetermined points (xᵢ, yᵢ) using known standard methods of automatic differentiation.

Furthermore, propagation loss predictions are obtained a weighted sums of multiple neural network evaluations. The physics-aware loss function Loss calculates a deviation between a predicted position-based propagation of radio waves and a measured position-based propagation. The predicted quantities are obtained according to the above partial derivatives.

$$\frac{d}{dx} \frac{d}{dy} NN ( θ , {x}_{i} , {y}_{i} ) .$$

In a second step S2, inputs comprising a training set of one or more spatial-loss fields and of one or more integrated spatial loss fields are received. A respective spatial-loss field is preferably given as a function SLF(x,y) returning a spatial loss field value at spatial coordinates (x,y). A respective integrated spatial-loss field is defined as an integral of the function SLF over a spatial domain between a transmitter 20 located at (xₜₓ, yₜₓ) and a receiver located at (xᵣₓ, yᵣₓ). The integrated spatial-loss field is preferably represented as a function ISLF(xₜₓ, yₜₓ), (xᵣₓ, yᵣₓ).

In a third step S3, the neural network parameters θ are initialized.

In a fourth step S4, the neural network parameters θ are trained by minimizing the loss function Loss, which implicitly depends on loss-the neural network parameters θ via the partial derivatives

$$\frac{d}{dx} \frac{d}{dy} NN ( θ , x , y )$$

and the evaluations

$$\frac{d}{dx} \frac{d}{dy} NN ( θ , {x}_{i} , {y}_{i} )$$

at points (xᵢ, yᵢ). The loss function Loss is mini by variation of the parameters θ. For such optimization tasks many efficient methods are available, e.g., based on a gradient descent of Loss with regard to θ.

In a fifth step S5, the spatial loss field SLF is evaluated via the mixed partial derivative of the trained neural network. The integrated spatial loss field ISLF is evaluated via the weighted sum of multiple evaluations of the trained neural network.

In particular, FIG. 1 shows a method for teaching the electronic computing device 10 comprising at least a machine learning algorithm for predicting a position-based propagation 12 of radio waves (FIG. 2) in the environment 14 (FIG. 2). Such a teaching is also referred to as training.

A mathematical model for the position-based propagation 12 is provided, wherein the mathematical model comprises at least a physical model for the propagation in the environment 14. The physical model relates physical quantities, like radio waves, their propagation, attenuation and reflection and attenuating or deflecting materials according to well-known physical laws.

Training data are generated for the machine learning algorithm. The training data comprise one or more measured propagation fields and/or a propagation domain. The propagation field specifies an area where the propagating radio waves shall be predicted. The propagation field may specify the spatially-resolved propagation loss, i.e. a path loss map or a spatial-loss field, or may specify a spatially-resolved field of a signal strength within the propagation domain.

The machine learning algorithm is trained by fitting the training data to the partial derivative of the neural network NN as partial derivative of the machine learning algorithm.

A prediction of a propagation loss is obtained by a weighted sum of multiple evaluations of the trained machine learning algorithm.

Furthermore, the training data additionally comprise second training data of propagation measurements, and e.g., measured signal strengths (RSSI) of radio waves. From these propagation measurements integrated spatial-loss fields ISLF can be derived as shown below.

The training of the machine learning algorithm additionally comprises fitting the second training data to weighted sums of evaluations of the machine learning algorithm as shown below.

Furthermore, according to first variant of the inventive method, the propagation loss prediction comprises a calculation of a two- or three-dimensional integral over a propagation field.

According to a second variant of the inventive method, the propagation loss prediction comprises a calculation of integrals over the propagation domain as line integrals over a propagation field.

A dimensionality of the calculation of the propagation loss prediction may be reduced by using a Radon transformation.

FIG. 2 shows a top view according to the embodiment of the method. In particular, the environment 14 is shown. In particular, it is shown that the mathematical model may comprise at least additionally a transmission power parameter and a free-space parameter of the propagation loss.

Furthermore, the propagation field at least may be predefined by a physical parameter 16 of the environment 14. For example, the physical parameter 16 defines environment geometry information, for example shown as a wall 18 in FIG. 2, by means of spatially resolved transmission coefficients.

In particular, embodiments of the invention comprises to use a new machine learning method that is based on known laws of physics involving the spatial loss field (SLF) as per eq (1). The invention further comprises applying the trained machine learning algorithm to a radio propagation problem. The spatial loss field may be based on a floor plan and obstacle material properties and training data may be obtained by means of RSSI measurements.

Embodiments of the invention are based on a novel physics-aware learning formulation, where a single neural network is preferably trained jointly on reproducing path loss measurements and reproducing information about the underlying spatial loss field SLF. The information about the spatial loss field may particularly comprise attenuation factors of objects in the propagation domain.

The formulation is based on a two-dimensional geographical area as a propagation domain where signal strengths SSI (xₜₓ, xᵣₓ) of the radio waves between the transmitter 20 located at (xₜₓ, yₜₓ)=xₜₓ=(x₀, y₀) and the receiver located at (xᵣₓ, yᵣₓ)=xᵣₓ=(x₁, y₁) is given by:

RSSI(xₜₓ, xᵣₓ)=G₀−ylog₁₀∥xₜₓ−xᵣₓ∥−∫ₓ_{ᵣₓ}^{x}^{ₜₓ}SLF(x)dx. (1)

In (1), the first component G₀ specifies a transmission power, the second component ylog₁₀∥xₜₓ−xᵣₓ∥ denotes a free-space component of the path loss, i.e. the propagation loss in absence of attenuating materials, and the integral represents the integrated spatial-loss field ISLF, which specifies an additional attenuation of obstacles within the propagation domain according to

ISLF(xₜₓ, xᵣₓ)=∫ₓ_{ᵣₓ}^{x}^{ₜₓ}SLF(x) dx. (2)

SLF denotes the spatial-loss field as defined above with x=(x, y) and y denotes a free-space component parameter.

The transmission power G₀ and free-space component parameter y can be assumed to be known as they can be measured or estimated using known methods. Hence, a main problem is to train the neural network NN to reproduce the spatial-loss field SLF and/or the integrated spatial-loss field ISLF. The latter explicitly specifies the transmission of radio waves travelling between different tx-rx pairs (x_{rx,j}, x_{tx,j}), indexed by the index j, through common building materials such as drywall, plexiglass, blinds, glass, plywood, etc.

Training data for learning the integrated spatial-loss field ISLF by the neural network NN may be obtained from signal strength measurements between different tx-rx pairs according to:

ISLF(_{rx,j}, x_{tx,j})=G−RSSI(_{rx,j}, x_{tx,j})−ylog₁₀∥x_{tx,j}−x_{rx,j}∥ (3)

resulting in a dataset of tuples [symbol] :=(x_{tx,j}, x_{rx,j}, ISLF(x_{tx,j}, x_{rx,j})) j∈J.

Training data for learning the spatial-loss field SLF by the neural network NN may be obtained from environment geometry information e.g., location of walls and their corresponding transmission coefficients. An exemplary spatial-loss field SLF is provided in FIG. 2, where shaded areas represent a building material with a high spatial loss and the white areas represent free space with very low spatial loss.

The joint physics-aware learning problem for reproducing the fields SLF and ISLF can be posed via the novel physics-aware loss function Loss.

According to the first variant of the inventive method the integrated spatial-loss field ISLF is calculated as a two-dimensional integral over the spatial-loss field SLF as propagation field. The two-dimensional integral is calculated over the rectangular domain [x₀, x₁]×[y₀, y₁] spanned by xₜₓ:=(x₀, y₀) and xᵣₓ:=(x₁, y₁), i.e.:

ISLF(xₜₓ, xᵣₓ)=∫ₓ_{₀}^{x}^{₁}∫_{y}_{₀}^{y}^{₁}SLF(x, y) dxdy. (4)

In this case, the physics aware loss function Loss is given by:

$$Loss ( θ ) = {\sum }_{i} ϕ ( S L F ( {x}_{i} , {y}_{i} ) - \frac{d}{d x} \frac{d}{d y} NN ( θ , {x}_{i} , {y}_{i} ) ) + {\sum }_{j} ρ ( I S L F ( {x}_{tx , j} , {y}_{tx , j} , {x}_{rx , j} , {y}_{rx , j} ) - ( NN ( θ , {x}_{tx , j} , {y}_{tx , j} ) - NN ( θ , {x}_{rx , j} , {y}_{tx , j} ) - NN ( θ , {x}_{tx , j} , {y}_{rx , j} ) + NN ( θ , {x}_{rx , j} , {y}_{rx , j} ) ) ) . \qquad ( 5 )$$

ϕ and ρ are square functions, absolute value functions or other appropriate loss functions like huber loss functions.

Here, the loss function Loss couples the training of the reproduction of the fields SLF and ISLF by using one loss function Loss involving two loss components for the fields SLF and ISLF.

Minimizing the loss function Loss fits the yᵢ) mixed-derivatives of the neural network

$$\frac{d}{d x} \frac{d}{d y} NN ( θ , {x}_{i} , {y}_{i} )$$

at the predefined positions (xᵢ, yᵢ) to the spatial loss field SLF(xᵢ, yᵢ), while simultaneously fitting the signed sum of network evaluations NN(θ, x_{tx,j}, y_{tx,j})−NN(θ, x_{rx,j}y_{tx,j})−NN(θ, x_{tx,j}, y_{rx,j})+NN(θ, x_{rx,j}, y_{rx,j}) at the distinct points (x_{tx,j}, y_{tx,j}), (x_{rx,j}, y_{tx,j}), (x_{tx,j}, y_{rx,j}), (x_{rx,j}, y_{rx,j}) for all j to the integrated spatial loss field ISLF(x_{tx,j}, y_{tx,j}, x_{rx,j}, y_{rx,j}).

According to the second variant of the inventive method the integrated spatial-loss field ISLF in equation (2) is calculated as line integral from starting point (x₀, y₀) to endpoint (x₁, y₁) which reduces the dimensionality of the integral, and training effort. For simplifying the line integral a Radon transform is carried out on the spatial coordinates. Then the loss function Loss is given by:

$$Loss ( θ ) {\sum }_{i} ϕ ( S L F ( {z}_{i} , {α}_{i} , {s}_{i} ) - \frac{d}{dz} NN ( θ , {z}_{i} , {α}_{i} , {s}_{i} ) ) + {\sum }_{i} ρ ( \text{} I S L F ( {z}_{0 , j} , {z}_{1 , j} , {α}_{j} , {s}_{j} ) - ( NN ( θ , {z}_{0 , j} , {α}_{j} , {s}_{j} ) - NN ( θ , {z}_{1 , j} , {α}_{j} , {s}_{j} ) ) . \qquad ( 6 )$$

The relationship between the (x, y)-coordinates and the Radon coordinates is given by

(z, α,s)−(x, y): (x, y)=(zsinα+scosα, −zcosα+ssinα). (7)

Then the starting point (x₀, y₀) and the endpoint (x₁, y₁) of the line integral are transformed using the bijection (x₀, y₀, x₁, y₁)→(z₀, z₁, α, s):

$$α = a tan 2 ( {y}_{1} - {y}_{0} , {x}_{1} - {x}_{0} ) + \frac{π}{2} . \qquad ( 8 )$$

$$and$$

$$[ \begin{matrix}{z}_{0} \\ {z}_{1} \\ s\end{matrix} ] = {[ \begin{matrix}sin α & 0 & cos α \\ - cos α & 0 & sin α \\ 0 & sin α & cos α \\ 0 & - cos α & sin α\end{matrix} ]}^{†} [ \begin{matrix}{x}_{0} \\ {y}_{0} \\ {x}_{1} \\ {y}_{1}\end{matrix} ] , \qquad ( 9 )$$

where (·)^{†} denotes the Moore-Penrose Pseudo-Inverse.

The following further illustrates a significant difference of the inventive training method to conventional training methods.

According to conventional training methods a neural network NN(θ, xᵢ, yᵢ) is trained to reproduce a given bivariate function ƒ(xᵢ, yᵢ) by minimizing:

Loss(θ)=Σᵢϕ(ƒ(xᵢ, yᵢ)−NN(θ,xᵢ, yᵢ)), (10)

where ϕ(·) is e.g. a square function or an absolute value function.

According to the inventive training method, on the other hand, the spatial of the neural network NN(θ, xᵢ, yᵢ) are trained by means of equations (5) or (6) to reproduce in particular the bivariate field SLF by minimizing the respective loss function Loss.

In this way the neural network NN(θ, x, y) is implicitly trained to reproduce with little effort spatial integrals in the form x1 f(x, y) dxdy by in case of equation (5) or in the form of line integrals in case of equation (6).

With that, the integrated spatial-loss field ISLF can be reproduced by the following weighted sum of evaluations of the neural network NN in case of equation (5):

∫ₓ_{ₗ}^{x}^{ᵤ}∫_{y}_{ₗ}^{y}^{ᵤ}ƒSLF(x, y) dxdy=∫ₓ_{ₗ}^{x}^{ᵤ}∫_{y}_{ₗ}^{y}^{ᵤ}ƒ(x, y) dxdy=NN(θ, xₗ, yₗ)−NN(θ, xᵤ, yₗ)−NN(θ, xₗ, yᵤ)+NN(θ, xᵤ, yᵤ). (11)

In case of equation (6), the integrated spatial loss field ISLF can be reproduced in an analogous manner by a reduced weighted sum of evaluations of the neural network NN.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for teaching an electronic computing device including at least a machine learning algorithm for predicting a position-based propagation of radio waves in an environment, the method comprising:
Providing a mathematical model for the position-based propagation, wherein the mathematical model comprises at least a physical model for the position-based propagation in the environment; generating training data for the machine learning algorithm comprising a propagation field and/or a propagation domain;
training the machine learning algorithm by fitting the training data to a partial derivative of the machine learning algorithm; and
obtaining a prediction of a propagation loss by a weighted sum of multiple evaluations of the trained machine learning algorithm.

2. The method according to claim 1, wherein training data additionally comprises second training data of propagation measurements, and training the machine learning algorithm additionally comprises fitting the second training data to weighted sums of evaluations of the machine learning algorithm.

3. The method according to claim 1, wherein the mathematical model comprises at least additionally a transmission power parameter and a free-space parameter of the propagation loss.

4. The method according to claim 1, wherein the propagation loss prediction comprises a calculation of integrals over the propagation domain are calculated as line integrals over a propagation field.

5. The method according to claim 1, wherein a dimensionality of the calculation of the propagation loss prediction is reduced by using a Radon transformation.

6. The method according to claim 1, wherein the propagation loss prediction comprises a calculation of a two- or three-dimensional integral over a propagation field.

7. The method according to claim 1, wherein for the propagation field at least one physical parameter of the environment is predefined.

8. The method according to claim 7, wherein the at least one physical parameter defines environment geometry information via transmission coefficients.

9. The method according to claim 1, wherein the machine learning algorithm is provided as a neural network.

10. A method for using the electronic computing device trained according to claim 1, wherein the position-based propagation in the environment is predicted by optimizing parameters of the neural network by minimizing a loss function.

11. The method according to claim 10, wherein a propagation field simulation is evaluated by the derivative of the machine learning algorithm and/or the propagation loss is evaluated by the weighted sum of multiple evaluations of the machine learning algorithm.

12. A computer program product, comprising a computer readable hardware storage device having computer readable program code stored therein, said program code executable by a processor of a computer system to implement a method according to claim 1.

13. A computer-readable storage medium comprising at least the computer program product according to claim 12.

14. An electronic computing device for predicting a propagation of radio waves in an environment, comprising at least one machine learning algorithm, wherein the machine learning algorithm is trained by the method according to claim 1.

15. An electronic computing device for predicting a propagation of radio waves in an environment, comprising at least one trained machine learning algorithm, wherein the electronic computing device is configured for performing the method according to claim 10.

16. A computer program product, comprising a computer readable hardware storage device having computer readable program code stored therein, said program code executable by a processor of a computer system to implement a method according to claim 10.
